(19) United States
(12) Patent Application Publication
(10) Pub. No.: US 2010/0223211 A1
(43) Pub. Date: Sep. 2, 2010

(54) Decision service method and system

(76) Inventors: Gregory A. Johnson, Bloomington, MN (US); John Perlis, Petaluma, CA (US); Dave A. Kennon, Petaluma, CA (US); Lorraine J. Webster, Petaluma, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 09/972,076

(22) Filed: Oct. 5, 2001

Related U.S. Application Data
(60) Provisional application No. 60/239,858, filed on Oct. 11, 2000.

(51) Int. Cl. G06F 17/00; G06F 9/44; G06F 15/16; G06F 3/048

(52) U.S. Cl. 706/11; 717/106; 709/203; 717/100; 715/853

(57) ABSTRACT

A real time decisioning service comprising a set of powerful tools accessible in ASP mode allowing an end user to create, configure, test, and deploy decision engines to automate real time decisions, comprising both expert and custom analytic models used within decision strategies, and comprising systems integration and strategy consulting is provided. An exemplary decision system is described.

### CROSS-REFERENCE TO RELATED APPLICATIONS

This application claims priority to U.S. Ser. No. 60/239,858, filed Oct. 11, 2000 (Attorney Docket No. ISAA0004PR).

### BACKGROUND OF THE INVENTION

1. Technical Field

The invention relates to decision engines. More particularly, the invention relates to a decision service in Application Service Provider (ASP) mode, comprising an all-purpose decision engine with optional predictive/descriptive models and optional consulting services.

2. Description of the Prior Art

The recent rapid growth of the Internet and the World Wide Web (Web) has expanded opportunities for electronic business methods and systems, including, for example, the insurance industry, financial markets, retail, telecom industries, and the like. However, although a great deal of information is available on the Internet, much of the business decision making takes place off-line. For example, and according to prior art techniques, when a consumer requests automobile insurance coverage from an insurance company, that insurance company must, among other things, evaluate the consumer's driving record. Typically, motor vehicle report and prior claim information is accessed. Then information about the driver and vehicle is added, e.g. if the driver is over 20 years old and is buying a red Maserati. The insurance company combines such information to make the decision of whether or not to underwrite a policy for the driver. This process can be done over the Web.

Decisioning systems having decision engines ranging from general purpose engines to specialty engines have been developed by various companies to date. A list of such known companies, each company with a brief description of its decisioning system position is presented below.

Computer Associates; Islandia, N.Y. It has a general purpose rule-based development tool that generates executable decision processes. It is described as “an enterprise component development environment for building intelligent, rule-based applications, components, and frameworks. It combines the power of component-based development with business rules automation to solve complex business problems and to build applications that can change quickly in response to changing business scenario. [Its] powerful code generation technology provides the flexibility to deploy these applications as standard distributed components, including ActiveX, COM/DCOM, CORBA, TXSeries (Encina) and Tuxedo, across a range of enterprise architectures and platforms.”

Versata; Oakland, Calif. The Versata E-Business Automation System utilizes a business rules automation technology assisting companies to create, deploy and modify e-business software applications used to transact online business. System components include: a rich, team-based development environment to define business rules and e-commerce presentation layer; an open, scalable platform to compile and execute business rules required to power an e-business; and links for e-Business applications to legacy resources.

Accrue Software; Fremont, Calif., with offices throughout the U.S., and in London. Its system is an integrated, scalable solution for knowledge discovery in databases. Components include: data mining engines (predictive); a proprietary back propagation neural network algorithm that allows classification and regression models; a tree induction algorithm that uses classification trees and rule sets to forecast categorical values; a hybrid tree induction algorithm that uses regression trees and K nearest neighbor techniques to forecast continuous values; a naïve Bayesian algorithm that builds classification and regression models based on conditional probabilities; data mining engines (descriptive); a flexible, adaptive clustering algorithm that uses evolution techniques to create groups of related items; a distance-based clustering engine that uses iterative optimization to create groups of related items; a partitioned, set-oriented association algorithm that determines the dependency or sequencing between events; a component serving as the transformation fabric of a decision series that integrates each of the mining engines with each other and with relational databases; a developer's graphical user interface into the decision series knowledge discovery suite; a Web analysis solution designed to provide in-depth, accurate and detailed analysis of Web site activities; and an analyzer that applies enterprise's business rules into the analysis process.

Firepond, Waltham, Mass., with offices throughout the U.S., Europe and Asia. Offers a suite, a multi-channel, e-business sales and marketing software system that is integrated from the ground-up. System components include: a business intelligence engine that allows companies to develop multi-tiered business rule models that govern how products are configured, offered and sold to individual customers; a commerce component that allows creating personalized interactions with customers over the Internet by providing dynamic content and recommendations based on customer needs; a process server that is a transaction-based workflow engine that manages the distribution of data between applications, linking customers to sales channels and business units; a maintenance and development platform for analyzing and managing function, data content, and processes; a process designer for organizations to create, manage and monitor transaction-based business processes; an integration connector designer allowing third-party applications or legacy systems to connect to the application suite; a tool for system administrators; a tool set for developing and deploying HTML and Java applications; and tools to manage parameters and business rules of software components.

ILOG, Paris, FRANCE, with offices in the U.S., England, Germany, Japan, Singapore and Spain. Developed optimization and visualization software as reusable components. ILOG products are used by developers and end users in telecommunications, manufacturing, transportation, defense and other industries. ILOG's products are in the data visualization, resource optimization and real time control categories.

Blaze Software, formerly Neuron Data, San Jose, Calif., and recently bought by HNC, with offices throughout the U.S., Europe and Japan. Has a suite that allows corporations and software vendors to deploy high-volume applications that reflects service abilities of a company's employees. Components include: an advisor builder that lets personalizes e-transaction responses, targets customer interactions, and brings individualized attention to Web self-service; includes a visual development environment for writing, editing, viewing, and testing personalization and e-business rules; fully localized into Japanese; an advisor rule engine individualizing e-business applications by monitoring, executing, and optimizing the performance of personalization and business rules; an advisor rule server letting customers interact simultaneously across all of a company's systems, while client manages rules that govern such interactions; an advisor for developers, packaged as a development environment for software developers, other vendors and internal development teams; a business rule solution for building expert systems and rule-powered applications; a user-interface development environment that is cross-platform and integrates with a business rules processor, and a component that provides services including prototyping, architecture and design development.

The Haley Enterprise, Sewickley, Pa. Has numerous products: a knowledge management and authoring environment for business people to author business policies and practices in form of business rules; a multi-threaded, server-based inference engine for business rule processing in transaction processing, client/server and internet applications; an efficient, embeddable inference engine for desktop and enterprise applications using COM and OBDC under Microsoft Windows 95 and NT on Pentium processors; a distributable and embeddable inference engine for Visual Basic and Internet Explorer using Java and COM; a runtime inference engine that uses a derivative of the Rete Algorithm.

Attar Software, Leigh, UK. Products include: data mining and analysis; a graphical Knowledge Based System (KBS) development package with in-built resource optimization, uses decision trees, also uses rule induction wherein examples, truth tables and exception trees are used to automatically generate decision trees to express logic in a more efficient way; a genetic algorithm optimizer used to determine optimal solutions to problems having many possible solutions, such as design, resource scheduling and planning and component blending; and a Windows runtime version to distribute copies of developed applications and deliver solutions on Internet/Intranets.

Lumina Decision Systems, Inc., Los Gatos, CA. Products: A visual software tool for creating, analyzing, and communicating quantitative business models; and an Analytica decision engine that allows access to Analytica models over the Web when called from business applications.

Decision Machines, Inc., Los Angeles, Calif. A set of components constituting a development environment that can be configured to reflect the way decisions are made in any organization, and used by everyone involved in the decision process, at the core is a decision engine that contains functions encompassing and extending traditional decision-making algorithms and methodologies. Users implement only those components of the engine that fit best the needs of their organization.

HNC, San Diego, Calif. Products relate to originations, account management, and account management fraud.

Experian Corporation, purchased CCN, Nottingham, UK. Related fields: enterprise wide originations and growing in account management.

AMS, Fairfax, Va. Enterprise wide, targeting originations and strong in account management. Described as “an enterprise-wide, customer-based decisioning platform that enables organizations to create, execute, measure and experiment with various customer decision strategies across the relationship cycle.”

While there are development tool sets allowing business users to define rule sets to automate business decision processes, none offers the unique combination of a totally flexible rule-authoring system, proprietary and non-proprietary analytics, and a usage-based ASP mode of delivery.

It would furthermore be advantageous to provide a decisioning service that supports incremental deployments, scales to enterprise, minimizes impact to internal IT resources, deploys quickly, runs quickly, puts control and total configurability into the hands of end users, and offers integration and strategy consulting.

### SUMMARY OF THE INVENTION

A real time decisioning service comprising a set of powerful tools accessible in ASP mode allowing an end user to create, configure, test, and deploy decision engines to automate real time decisions, comprising both expert and custom analytic models used within decision strategies, and comprising systems integration and strategy consulting is provided.

### BRIEF DESCRIPTION OF THE DRAWINGS

FIG. 1 shows a block diagram of the components of the decisioning service according to the invention;

FIG. 2 shows a schematic diagram for an end user developing the rules, models, and strategies, referred to simply as the rules, from analysis to execution according to the preferred embodiment of the invention;

FIG. 3 shows a screen print of an example of a main opening view of the designer component according to the invention;

FIG. 4 shows an example of a workflow screen from the designer component according to the invention;

FIG. 5 shows an example of a view of a strategy tree according to the invention;

FIG. 6 shows an example of a representation of assignments of expressions in sequence according to the invention;

FIG. 7 is an example of a representation of the data dictionary according to the invention;

FIG. 8 shows examples of user defined functions (UDFs) according to the invention;

FIG. 9 shows an example from a model editor in FIG. 2 according to the invention;

FIG. 10 shows views from the testing environment according to the invention;

FIG. 11 shows a view of an example of projects and parts browser according to the invention;

FIG. 12 shows a Web page from the Web-based dynamic reporting feature according to the invention;

FIGS. 13a and 13b show views from an example application, credit transaction authorization decisioning according to the invention;

FIGS. 14a and 14b show views from an example application, interactive customer management according to the invention;

FIG. 15 shows a view from a workflow outline tree report for an example application, customer relations management according to the invention;

FIG. 16 shows a view from a workflow outline tree report for an example application, accounts receivable management according to the invention;

FIG. 17 shows a view from a workflow outline tree report for an example application, lifetime value score according to the invention; and

FIG. 18 shows a view of an example data structure according to the invention.

### DETAILED DESCRIPTION OF THE INVENTION

A real time decisioning service comprising a set of powerful tools, such as a totally flexible rule-authoring tool, accessible in ASP mode that allow an end user together with clients and partners to create, configure, test, and deploy ubiquitous decision engines for automating real time decisions, comprising expert and/or custom analytic models used within decision strategies, and comprising systems integration consulting and strategy consulting is provided. The invention provides the intelligence inside other vendor software solutions, for example, intelligent “run-the-business” software with which to drive eCommerce. An all-purpose decisioning engine operating from a data center is embedded within such “run-the-business” software applications. The invention leverages the domain expertise of clients, partners, consultants, and the like, as it allows for domain expert contributions. It is a net-centric ASP offering allowing clients to implement real time decisioning over the Internet, providing an open, industry standard architecture for software compatibility, and providing decision engines from which usage-based revenues can be derived, for example.

The preferred embodiment of the invention operates in Application Service Provider (ASP) mode using an XML interface. The invention comprises a secure Internet Web site, thereby ensuring the privacy of end user strategies and end user and consumer data. The invention minimizes the amount of hardware and software the end user must purchase and maintain. It can be appreciated that the invention can run at an end user's Web site. It can also be appreciated that a Virtual Private Network (VPN) can also be used.

The preferred embodiment of the invention is intended and adaptable for a variety of buyer categories. Examples of such buyer categories are described below. It should be appreciated that the examples below are not exhaustive, and that the invention is intended for any user and any situation in which real time decisioning in ASP mode is useful.
Prospects within vertical markets. Examples of vertical industries are the financial services, retail, and telecom industries. Functional areas within these vertical industries can also be prospects, such as, for example, asset management, brokerage, Internet operations, and merchandising.
Fortune 1000 companies. The preferred embodiment of the invention can also host decision engines having logic applied in horizontal markets, such as, for example, sales, human resources, procurement, etc. More specifically, the invention is provided as a decision engines development environment for operations managers in the Fortune 1000, whereby the operations managers respond more quickly to the demands of business managers for real time decisioning capabilities.
Consultants and Value Added Resellers (VARs). The preferred embodiment of the invention comprises training consultants and software integrators to build decision engines that operate from a data center that supports clients' business applications.

The preferred embodiment of the invention, an ASP service provided to clients and partners comprising a decision system, optional analytic models, and optional system integration and consulting is further described as follows:
Decision system. In the preferred embodiment of the invention, the decisioning related software, the decision system, is resident at a data center and is accessible over the Internet. The software allows business users working with project designer applications to design, test, and deploy decision systems accessible over the Internet and used for automating decisions within the business applications of business users. An exemplary decision system is disclosed and described below in the section, An Exemplary Decision System. For an example of an embodiment of the decision system according to the invention and in an automobile underwriting system, refer to U.S. patent application, Insurance Decisioning Method and System, 09/757,730 (Jan. 9, 2001). For an example of another embodiment of the decision system according to the invention, refer to U.S. patent application, Electronic Customer Interaction System, 09/496,402 (Feb. 2, 2000). The disclosed decision engine is comprised of strategy trees, business rules, analytic models and user defined functions, sometimes referenced in this document simply as the rules, for making decisions. Project designers, experts knowing how to use a designer component of the preferred decision system, rely on the users and/or strategy consultants for the domain expertise needed to construct optimal solutions to business problems.
Analytic Models (optional). Such models provide expertise and judgments and are pooled or are custom predictive and/or decision models to fit the needs of a service user. Such models predict risk, revenue, response, attrition, or other similar behaviors. These decision models aim to arrive at optimal decisions given an appropriate context.
Systems integration and consulting (optional). Systems integration consulting and strategy consulting are provided.

The preferred embodiment provides a robust development platform for decision engines leveraged across multiple points in a customer's development lifecycle in multiple target markets. Thus, the disclosed decision service eliminates redundant development efforts and reduces time to market. The disclosed decision system is a blank slate for creating specialty engines with friendly user interfaces. That is, the disclosed tools that allow business users to create, configure, test, and deploy decision engines also serve as a technology platform made up of flexible software components used for building special purpose decision-oriented applications with user interfaces customized to particular business or functional purposes. The open software architecture follows Extensible Markup Language (XML) standards for Internet communications.

The disclosed decision service is not a single offering. Rather, it is offered in the four preferable categories, as follows. The disclosed decision service is offered:
Bundled with appropriate business-specific project templates representing decision engine design, with optional proprietary or non-proprietary consulting, tools, models, and reports, as a complete ASP solution in a variety of business contexts, such as insurance.
To clients and prospects as a generic decision engine factory accessible over the Internet. The target includes functional areas of traditional vertical markets, e.g. asset management, brokerage, Internet operations, and merchandising, as well as Fortune 1000 companies in industries, such as, for example, manufacturing and eCommerce.
To consultants and systems integrators (VARs) as a decision engine creation facility, with delivered engines to be hosted in ASP mode in a predetermined data center, and with the disclosed designer portion of the exemplary decision system uses a preferred authoring language for executing building decision engines according to the invention. The target comprises consultants and systems integrators with widespread reach and domain experts in areas otherwise lacking such.
By partnering with vendors specializing in particular applications, such as, for example in horizontal markets, such as procurement and human resource management. Tailored engines are created serving as decisioning sub-systems for such applications. For example, a created cross-sell engine or a customer valuation engine is particularly suited to making better real time personalization decisions according to the preferred embodiment of the invention. In such situations, the results of an engine configured in the form of executable analytics can be provided, for example, from a credit bureau scoring engine. In this mode, the end user cannot alter the design of the strategies or models embedded in the software. For example, a black box scoring capability, i.e. with intelligence inside is offered.

The preferred method of implementing the service according to the invention comprises either:
Basic ASP mode, in which the client sends data to a data center and receives back decisions in real time, or
Enhanced ASP mode, in which an additional layer of coordinating software or services link the decision engine to netsourced and/or external data, and maintains a transaction log of decisions made that can be accessed by the client and used for billing and reporting. The previously cited U.S. patent application, Insurance Decisioning Method and System, 09/757,730 (Jan. 9, 2001) provides an example of the enhanced ASP mode.

Following are some examples of situations in which end users directly benefit from the disclosed decision service:
When a business requires decisions to be made on a large number of transactions;
When rules, policies, or strategies can be formulated to automate such decisions;
When decisions can benefit from predictive analytics;
When changes to rules, policies, and strategies must be reflected quickly;
When it is desirable to test new strategies before roll out and to execute champion/challenger strategies; and
When it is desirable to put control and configurability into the hands of the end users.

Following are some examples of typical industries and areas within the industries that are suitable for using the disclosed decision service:
Marketing, account management, and fraud detection areas of the financial services industry;
Premium and eligibility determination in the insurance industry;
Scorecard delivery in the credit bureau industry; and
Providing a cross-sell engine to electronic customer relations management (eCRM) vendors.

It should be particularly appreciated that the disclosed decision service also supports incremental deployments, scales to enterprise, minimizes impact to internal IT resources, deploys quickly, and executes quickly.

It should also be appreciated that the disclosed all-purpose decision engine in ASP mode allows defining input and output definitions, creating or changing business rules, modifying strategies, adding a new action or treatment, inserting a champion/challenger experiment for testing a new strategy, modifying characteristic generations, and installing a revised model, such as, for example, profitability, risk, or attrition.

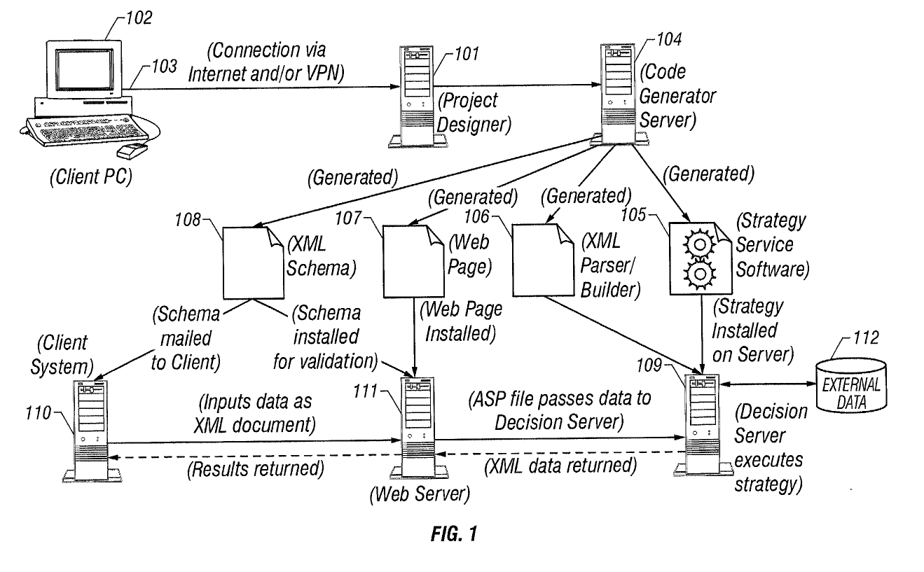

The preferred embodiment of the invention is described with reference to FIG. 1. FIG. 1 shows a block diagram of the components of the decisioning service according to the invention. A client, or end user, desires to work with rules, models, and/or strategies, referred to herein simply as rules, on a computer system 101 having project design software from the end user's personal computer 102. The client's personal computer (client PC) can represent other starting positions, such as, for example, a computer terminal at a bank. The client PC 102 connects to the project designer 101 via the Internet and/or a virtual private network (VPN) 104. The end user has the option to use consulting services according to the invention for developing and refining rules. When the end user is satisfied with the rules, control is passed to a code generator server 104 for generating code to be used in production. The code is typically in XML and/or CGI for ASP mode.

In the preferred embodiment of the invention, the code generator server 104 generates four kinds of outputs. The first type of output is strategy service software 105 that gets installed on a decision server 109 for executing strategy. The decision server 109 optionally is linked to outside data resources for additional relevant data. For example, in an insurance decisioning system, external data resources providing additional data may be as external reports and vendor subscriber codes.

A client system 110 hosting an application, such as, for example, a call center server hosting a call center business application, needs to process business data using the decisioning service. The client system 110 sends data to the decision server 109 via a Web server 111 in ASP mode. Specifically, the client system 110 sends data as an XML document to the Web server 111, which, in turn, delivers a corresponding ASP file to pass the data to the decision server 109.

The decision server 109 processes the data according to the strategy installed by client. The decision server returns processed and output data in XML format to the Web server 111, which, in turn, delivers results to the client system 110. For example, in the call center scenario, a delivered result to a call center may be instructions to the end user on what to say to the end user's client, such as, “Tell your client the following . . . . ”

Also in the preferred embodiment of the invention, the decision server 109 may require an XML parser/builder 106 generated by the code generator server 104 for reading data conforming to an XML schema 108, also generated by the code generator server 104. The generated XML schema 108 is provided to the client system for collecting input data and ensuring the input data from the client system conforms to such XML schema. It is appreciated that a copy of the XML schema 108 is passed to the Web server 111 for use in error handling. That is, the copy of the XML schema 108 residing on the Web server 111 validates input data intended for the decision server 109.

In the preferred embodiment of the invention, the code generator server 104 generates a Web page 107 that is loaded onto the Web server 111 for facilitating communication in ASP mode between the client system 11 and the decision server 109. The Web page 107 serves as an external interface to the decision engine. It is the address to which the input data is sent. Once it receives the input data, it calls the parser/builder 106 to convert the XML format data into a format that can be processed by the decision engine. Once the data has been processed, the Web page returns the results via XML to the client.

The preferred embodiment of the invention provides a complete process for using a decision engine from analysis to production, as follows. The process is divided into two general categories: assembly and delivery.

Sequential tasks within the assembly category comprise:
Defining input and output structures;
Importing analytical models and strategies;
Adding rules, modifying decision actions, and general tweaking of the engine; and
Testing.

Sequential tasks within the delivery category comprise:
Fueling the engine with data from various sources; and
Generating power in the form of better decisions.

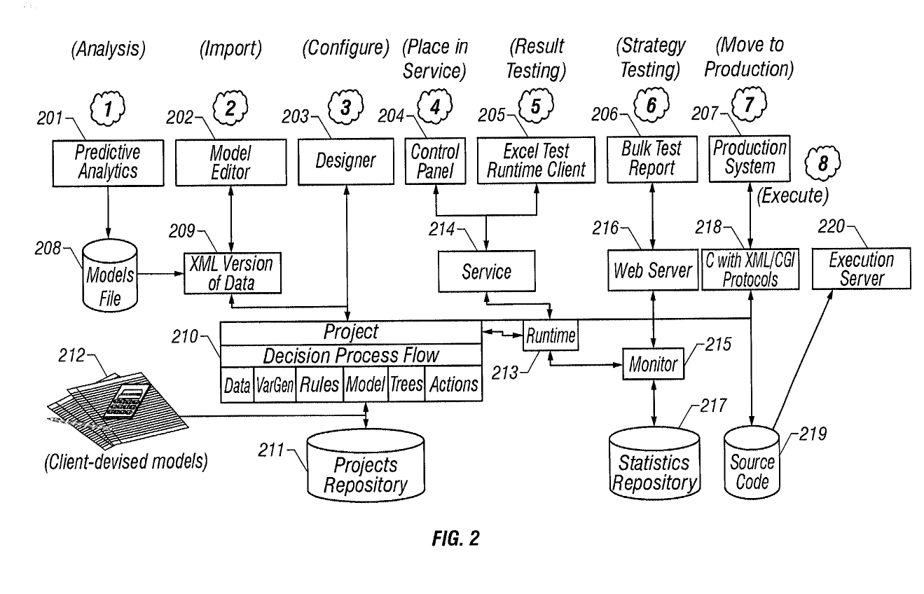

The process from analysis to execution can be described with reference to FIG. 2. FIG. 2 shows a schematic diagram for an end user developing the rules, models, and strategies, referred to simply as the rules, from analysis to execution according to the preferred embodiment of the invention. An end user uses a predictive analytics tool 201, proprietary or non-proprietary, that takes as input historical data and outputs a models file 208 having the rules defined within.

According to the preferred embodiment of the invention, a model editor component 202 is optionally used for automatically converting the models file 208 into an XML version of the data representing the rules, and importing the XML data into a designer component 203. The designer component 203 provides a means for designing rules by using projects. The preferred embodiment of the invention provides designing software by which the end user uses graphical user interfaces to generate the data, variables, rules, models, including imported client-devised models 212, such as, for example, a SAS model, trees, and actions required in a particular project 210. An exemplary project design process is described in detail below. Such projects are stored in a repository 211 for future reference, should an end user desire to modify and/or manipulate an already created project.

According to the preferred embodiment of the invention, the end user validates and/or verifies the rules, models, and strategies specified in the project 210. A runtime or executable version of the project 213 is generated for testing. By means of a service 214, the end user is allowed to execute rules in runtime mode. According to the preferred embodiment of the invention, the service 214 is a type of wrapper for a control panel 204 and an Excel testing program 205. It should be fully appreciated that the scope of the invention includes any testing environment in which the end user can verify and validate the rules.

After the rules have been validated and verified, more robust testing, including specifically overall strategy is performed, according to the preferred embodiment of the invention. An end user by means of a monitor 215 and a Web server 216 for ASP mode stress tests the rules, models, and strategies by passing a large number of transactions through the system, such as, for example, 10,000 records or transactions. A bulk test report 206 is generated for review. Similarly, predefined specific parts of rules, models, and strategies are monitored for hits. That is, the preferred embodiment of the invention tracks statistics on the rules, models, and strategies reflecting if the rules, models, and strategies were used and how many times. It should be fully appreciated that the scope of the invention allows for other types of statistical tracking that relate to the effectiveness of rules, models, and strategies. The statistics for the bulk test are stored in a statistics repository 217.

An end user not satisfied with rules, models, or strategies can edit, modify, and manipulate them by returning to the designer 203.

When the end user is satisfied with the rules, models, and strategies, production code is generated for the rules, models, and strategies 207. In ASP mode, the preferred language for the generated code is C 218. The source code 219 ultimately is loaded on an execution server 220 for production.

It is instructive to view the previously discussed process by comparing the process from analysis 201 to strategy testing 206, of FIG. 2, to activity performed on the project designer server 101 of FIG. 1. Similarly, the move to production process 207 of FIG. 2 can be compared to activity on the code generation server 104 of FIG. 1. Finally, the activity on the execution server 220 of FIG. 2 can be compared to the activity on the decision server 109 of FIG. 1. It should be appreciated that the invention is by no means limited to requiring the distribution of work on specific servers as presented in FIGS. 1 and 2. Rather, FIGS. 1 and 2 show equally preferred embodiments of the invention.

According to the preferred embodiment of the invention, the decision system designer (FIG. 1 101 and FIG. 2 203) comprises a configuration tool in a visual interactive development environment, in which the decision process is visually represented as an outline and/or graphical trees. The designer uses a data dictionary of request, response, and other variables, and uses Web-based reporting.

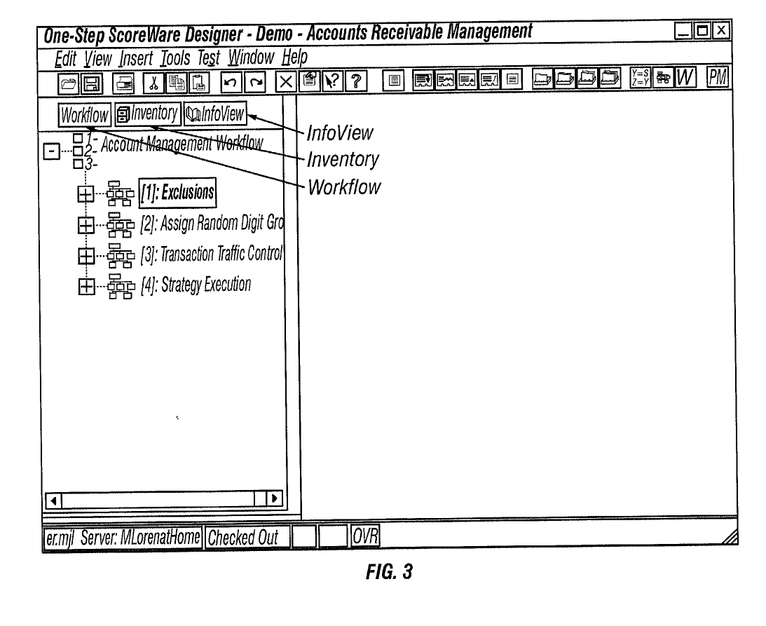

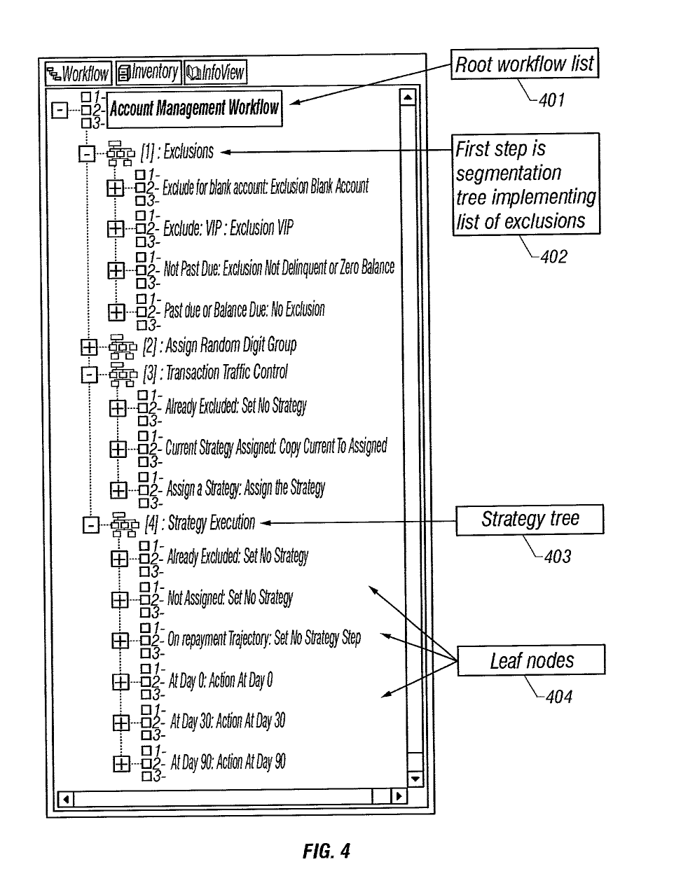

FIGS. 3-18 described below show examples from an embodiment of the invention. Further details of features in the figures are provided in the section below, An Exemplary Decision System.

FIG. 3 shows a screen print of an example of a main opening view of the designer component according to the invention. The example implementation is an account management decisioning system in which three tabs, InfoView, Inventory, and Workflow are provided for categorizing the information.

FIG. 4 shows an example of a workflow screen from the designer according to the invention. The system is the account management decision system of FIG. 3 and the Workflow tab view. A tree network is presented with the top level representing a root workflow list 401, sub-levels representing exclusions 402 and a strategy tree 403 with leaf nodes 404.

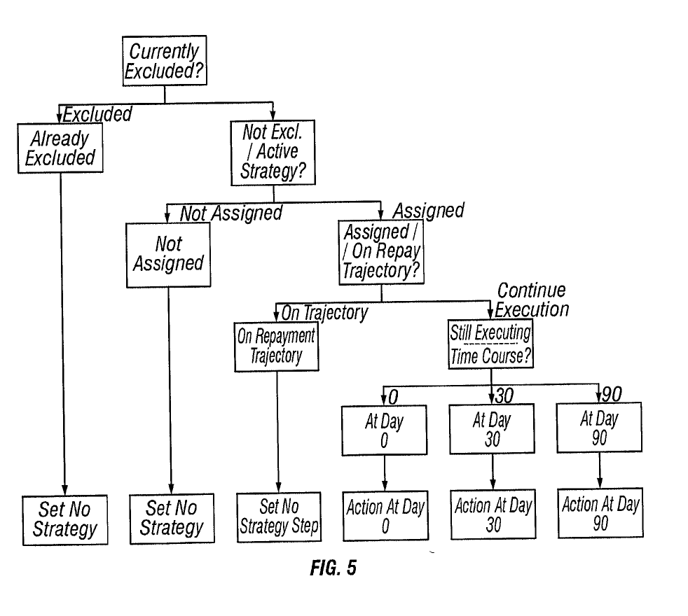

FIG. 5 shows an example of a view of a strategy tree according to the invention.

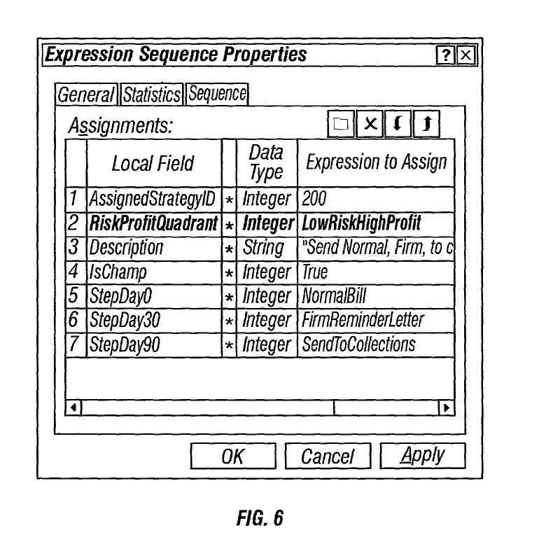

FIG. 6 shows an example of a representation of assignments of expressions in sequence according to the invention. A more detailed description of expression sequences is described below. In FIG. 6, the following variables have been assigned the following expressions in Table A, as follows.

TABLE A
AssignedStrategyID = 200
RiskProfitQuadrant = LowRiskHighProfit
Description = Send Normal, Firm, to collections - Low Risk - High Profit
IsChamp = TRUE
StepDay0 = NormalBill
StepDay30 = FirmReminderLetter
StepDay90 = SendToCollections

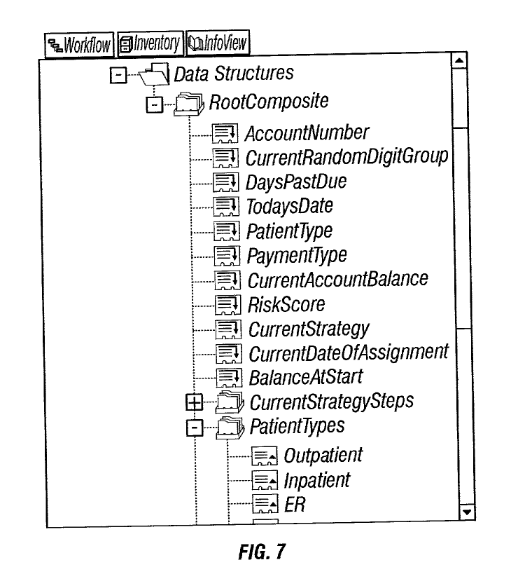

FIG. 7 is an example of a representation of the data dictionary according to the invention. Note that the data is displayed in the Inventory view from the inventory tab of FIG. 3. Examples of types of data in the preferred embodiment of the invention are, but are not limited to the following: numeric, float, string, input field, input data segment, constant, derived field, local field, output data segment, and array.

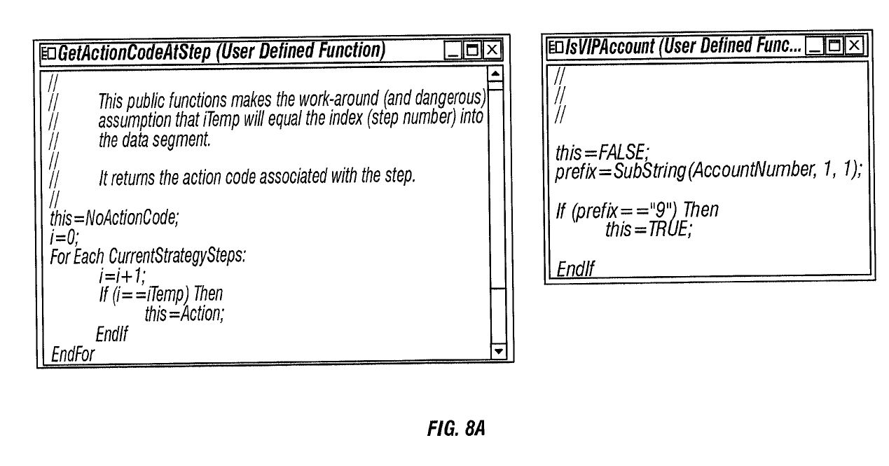

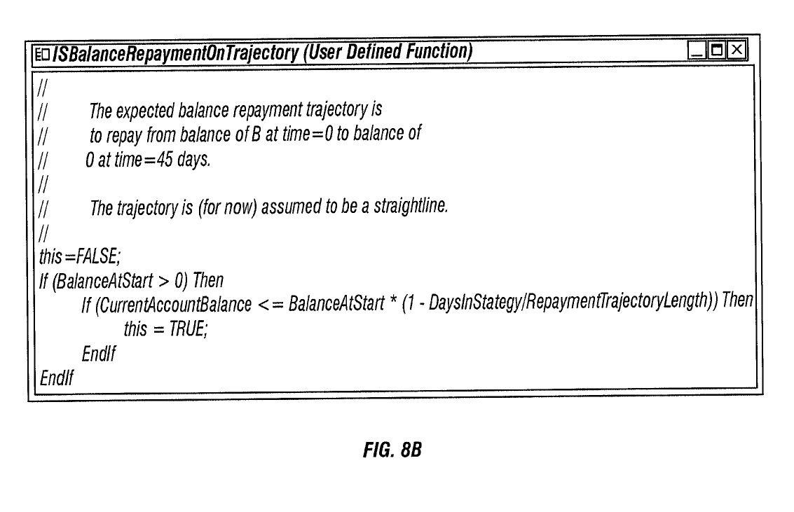

FIG. 8 shows examples of user defined functions (UDFs) according to the invention.

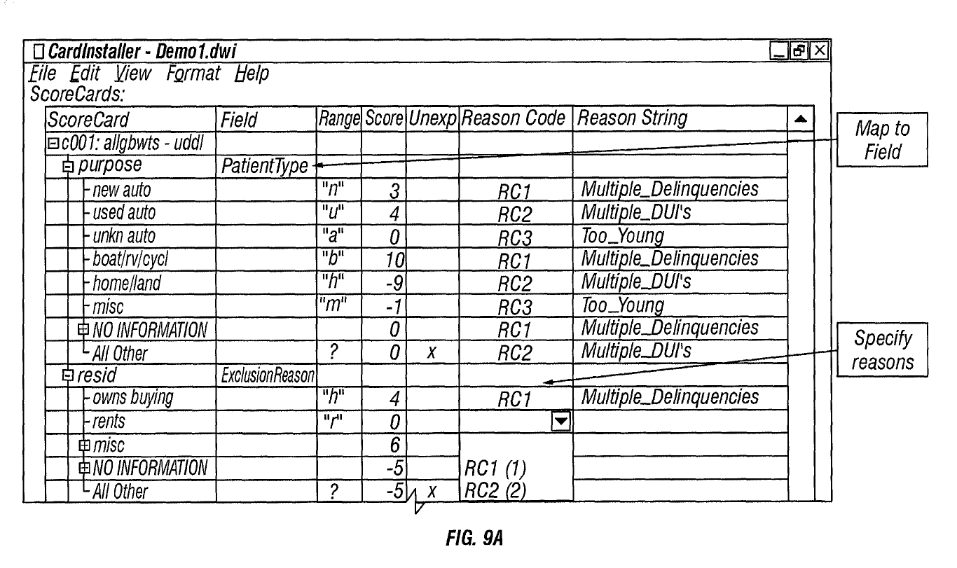

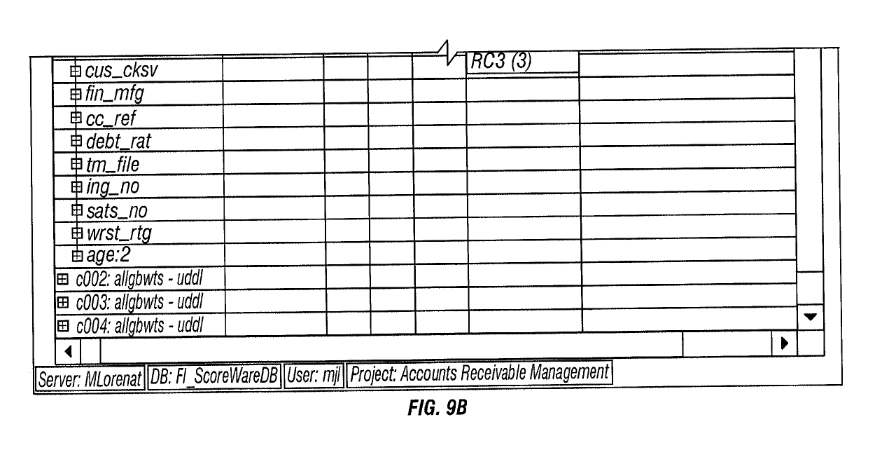

FIG. 9 shows an example from a model editor in FIG. 2 according to the invention.

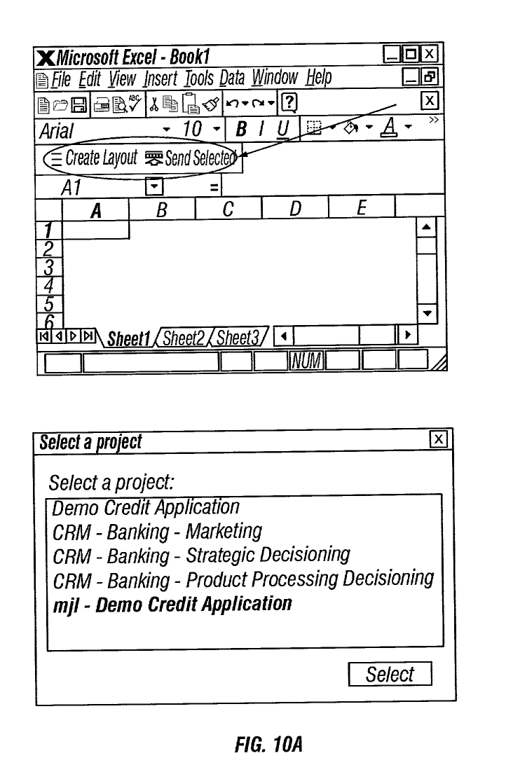

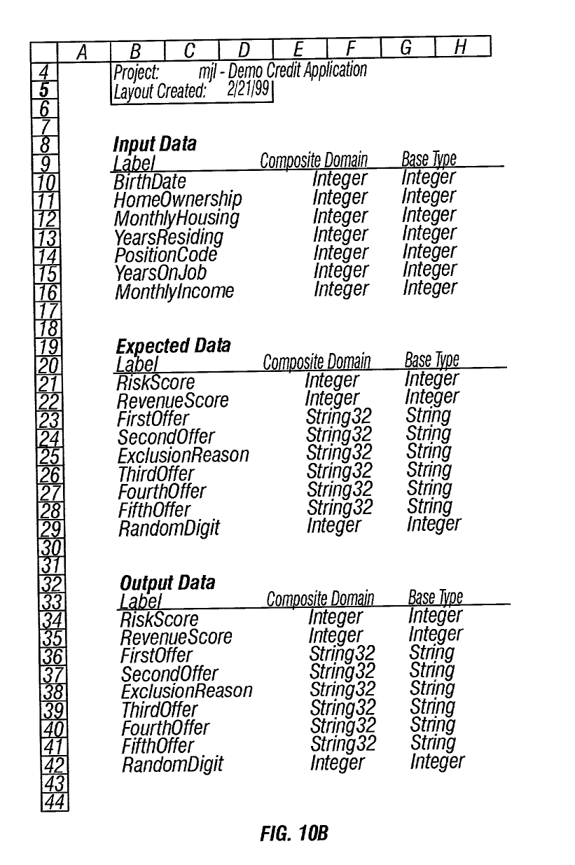

FIG. 10 shows views from the testing environment according to the invention.

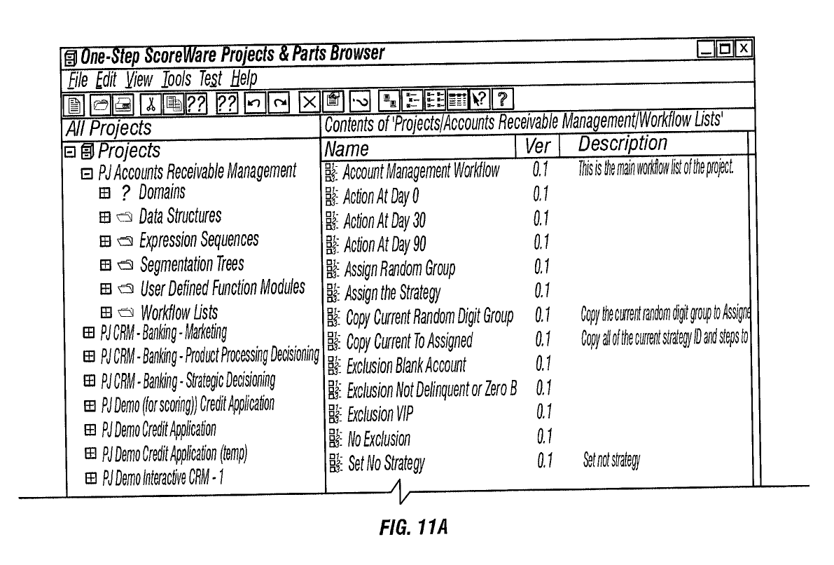

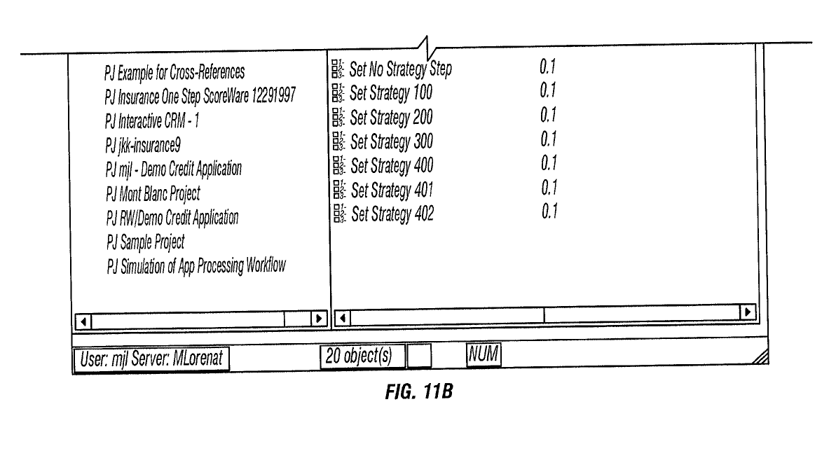

FIG. 11 shows a view of an example of projects and parts browser according to the invention.

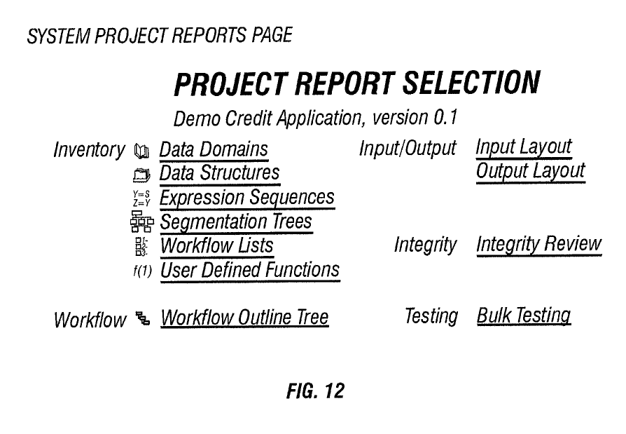

FIG. 12 shows a Web page from the Web-based dynamic reporting feature according to the invention.

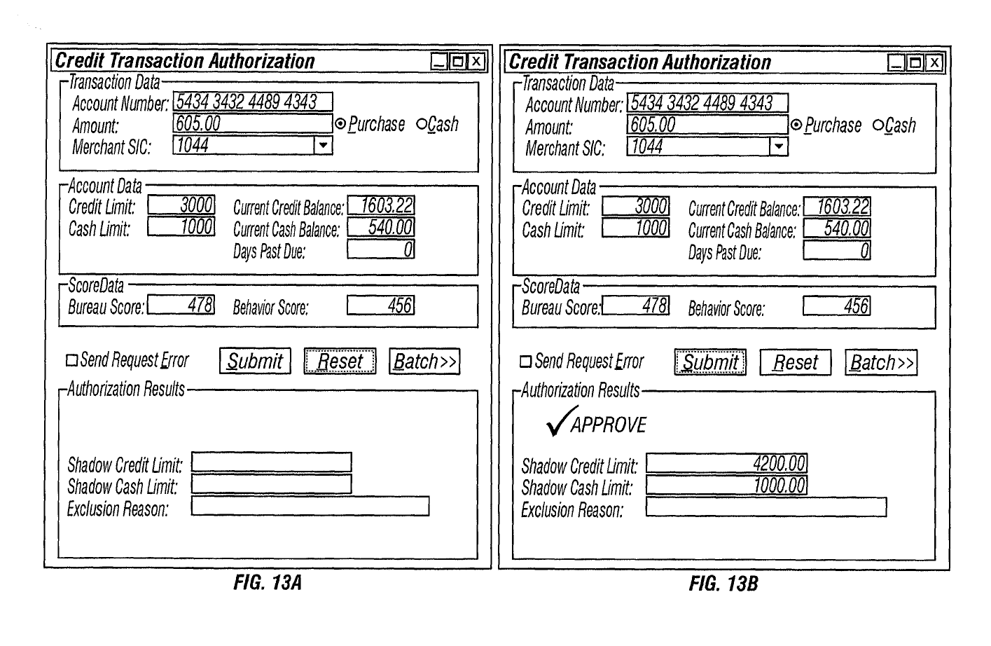

FIGS. 13a and 13b show views from an example application, credit transaction authorization decisioning according to the invention.

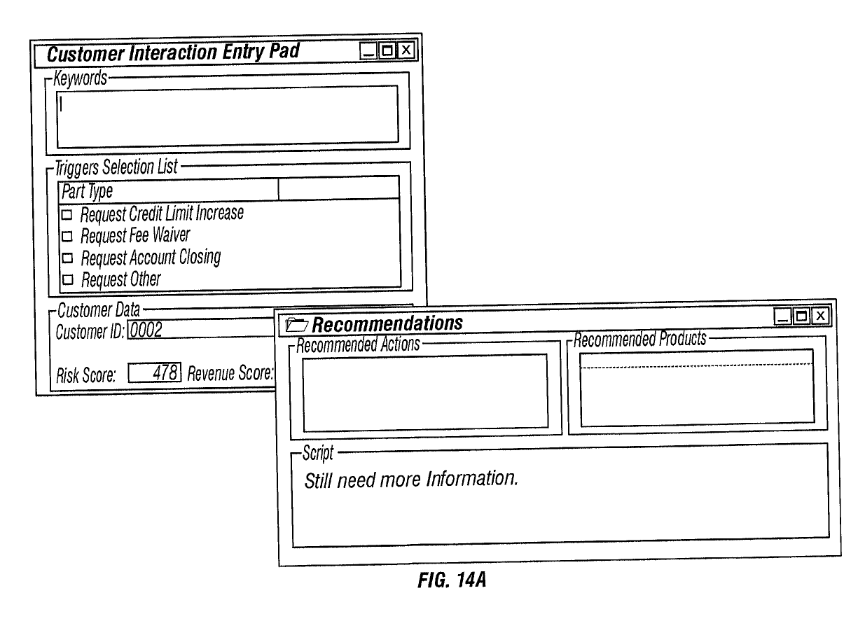

FIGS. 14a and 14b show views from an example application, interactive customer management according to the invention.

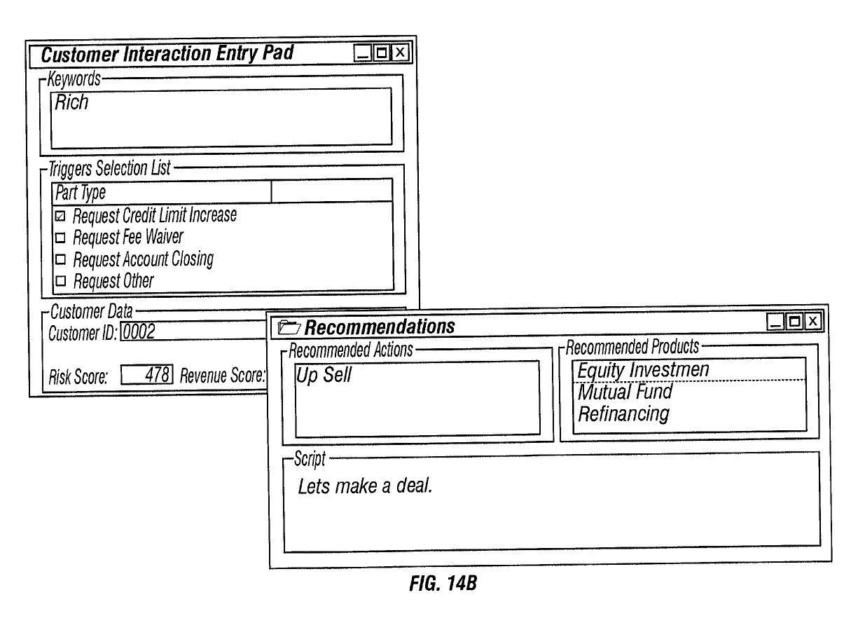

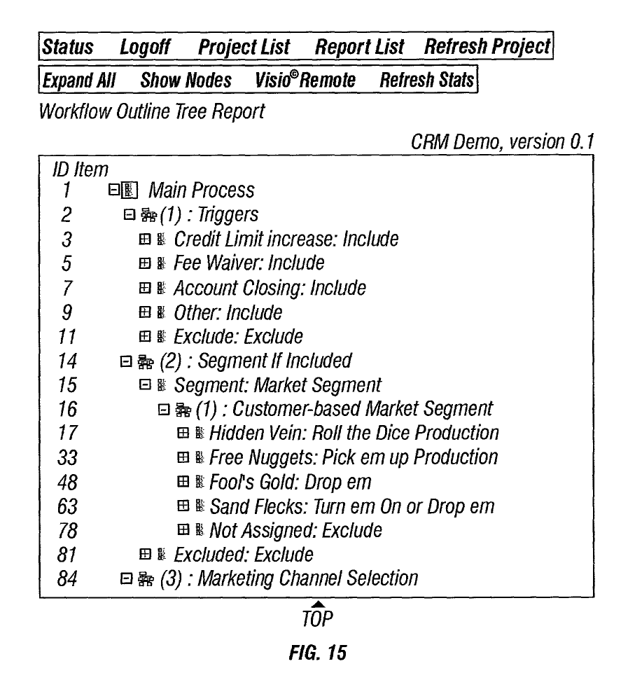

FIG. 15 shows a view from a workflow outline tree report for an example application, customer relations management according to the invention.

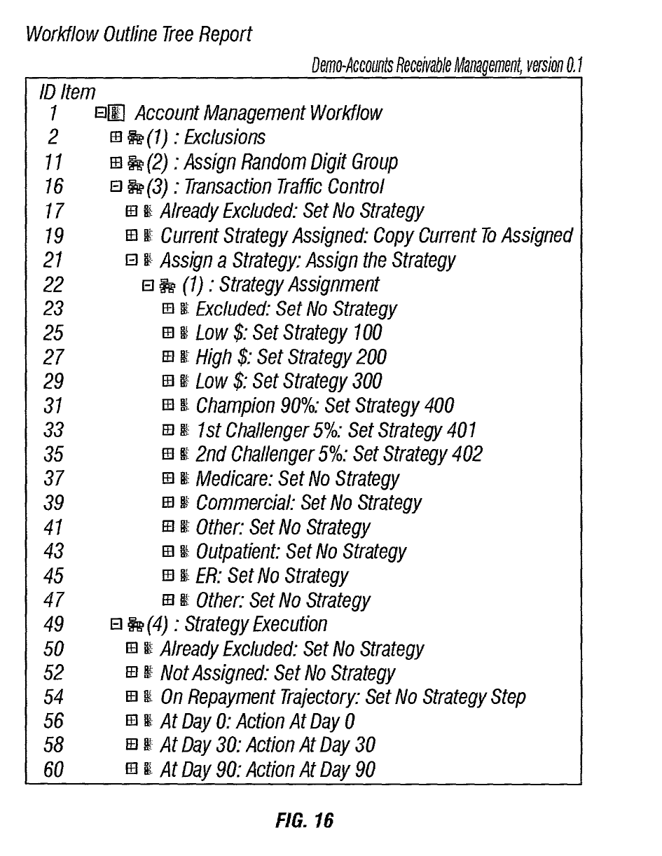

FIG. 16 shows a view from a workflow outline tree report for an example application, accounts receivable management according to the invention.

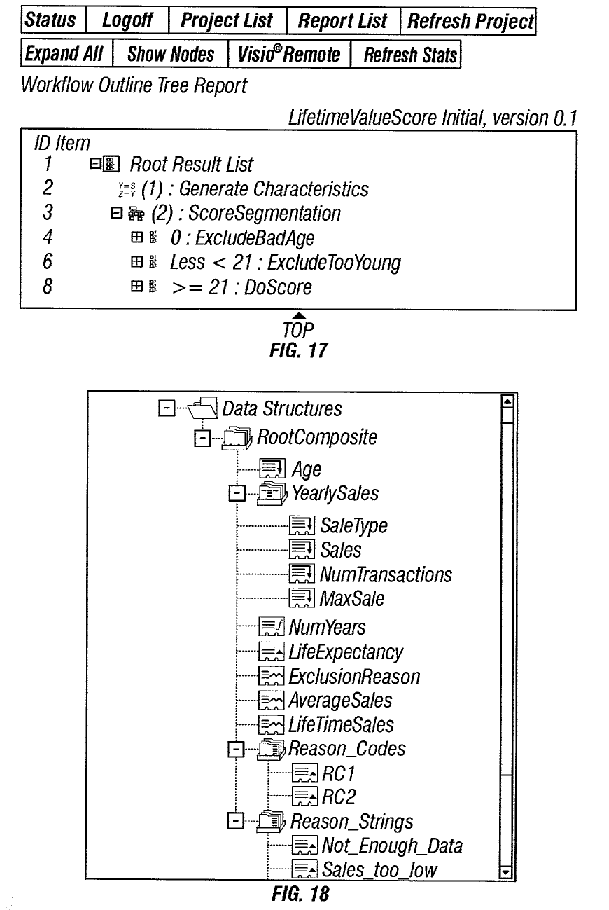

FIG. 17 shows a view from a workflow outline tree report for an example application, lifetime value score according to the invention.

FIG. 18 shows a view of an example data structure according to the invention.

The preferred embodiment of the invention incorporates the Fair, Isaac Decision Service™ manufactured by Fair, Isaac and Company, Inc. of San Rafael, Calif., USA, as the expert decisioning system described below. Details of the Fair, Isaac Decision Service™ can be found in Fair, Isaac Decision System User Guide, Printing 1.0 (US) (Sep. 26, 2000), Fair, Isaac Decision System Reference Guide, Printing 1.0 (US) (Oct. 3, 2000), and Fair, Isaac Decision System System Guide, Printing 1.0 (US) (Sep. 28, 2000). Those skilled in the art will appreciate that other expert decisioning systems may be substituted for Fair, Isaac Decision Service™.

### An Exemplary Decision System.

### The Decision Engine

The preferred embodiment of the invention comprises a decision engine, accessed over the Internet in ASP mode or neatly and natively integrated into an enterprise workflow on its appropriate target platform. Waiting for a request, it idles; and, when called from other programs, the decision engine revs up and promptly responds to requests for decisions. The fuel for the engine is data. A calling program prepares and sends data to the decision engine; and, in real time, the engine processes it and returns a reply that may include scores, reason codes, actions, and other calculated results or decisions.

An end user can easily assemble the basic design of an engine, or can build upon the framework of a decision process template or a copy of a previously designed engine. The details of the engine can be informed from two sources: (1) end user models, expertise, policies, and judgement, and (2) Fair, Isaac's models and strategies built upon the end user's historical data with Fair, Isaac's prodigious domain expertise.

The decision engines that can be fashioned are entirely configurable in design. An end user can create new decision processes to help address new business problems, or can experiment with existing decision processes, improving decisions over time through controlled champion/challenger testing. Champion/challenger testing is where the end user can compare competing strategies in a statistically valid way so that the end user can determine which strategy produces the best results. The existing strategy is the champion; the new strategy is the challenger. As a new strategy proves its effectiveness, it can be applied to a greater percentage of the end user's data. When a challenger becomes a new champion, a strategy design cycle begins.

### Component Architecture

The preferred embodiment of the invention is architected for integration with an end user's existing systems. The decision engine may be accessed over the Internet or executed in the end user's mainframe, UNIX, or NT platforms. That is, the end user's existing systems will be able to accommodate new or newly revised decision engines with minimal IT involvement.

The end user can build upon the component architecture and create new alternative design-time user interfaces that are customized to present a particular business context to a particular set of business users. Furthermore, the end user can automate the importation of existing models or strategies into decision engines that the end user creates.

### Components

The preferred embodiment of the invention comprises the following components:

Designer. A key visual development environment that enables the end user to create and configure decision engines.

Reporting Facility. Web-based design-time configuration reports and run-time testing results.

Run-time Server. A Microsoft Windows NT-based server that supports the run-time execution of configured decision engines. End user operational systems can make calls or requests to this server; and the server executes the decision engine to process the request and returns results to the requesting system.

C Requester. Tool generates a C module that represents the business rules, strategies, and decisions of the configured decision engine. The code of this module can be uploaded to a target platform, compiled, and called as a module via a C function call from the end user's requesting systems.

COBOL Requester. (Optional for client installation mode) Tool generates a COBOL module that represents the business rules, strategies, and decisions of the configured decision engine. The code of this module can be uploaded to a target platform, compiled, and called as a module via a COBOL call statement from the end user's requesting systems.

### Use of Models

The end user can incorporate models into the decision system environment. Along with other rules and criteria, the end user can use models to predict or describe many types of customer behavior, including the likelihood to respond to an offer, expected customer revenue/profit/lifetime value, or the likelihood to click-through to purchase on a Web site.

Models can be predictive judgmental (expert), pooled or custom-developed from historical data. They can be decision models that aim to arrive at optimal decisions, given their context. A wide range of models can be developed for the decision system.

### ASP Mode Overview

A preferred embodiment of the invention operates in ASP mode. When accessed in ASP mode, Fair, Isaac hosts the software, so that the end user isn't concerned with the time, cost and technical details of installation, servicing and upgrading of the hardware and operating systems software on which it runs. The software is accessed from end user business applications software using industry standard protocols over the Internet or a Virtual Private Network. Thus, the software is highly scalable and easy to integrate with the end user's current computing and operational environment.

In the ASP environment, the end user designs decision engine projects from a client PC, which is connected to designer software resident at the host site. Once the end user completes the design of a project, the host generates the supporting code and installs it on a decision server. In parallel with this, the host generates an Extensible Markup Language (XML) schema that corresponds to the project, and is used to define the input and output structures that the end user's business application uses when making calls to the decision server. When accessed over the Internet, the end user's client PC sends inquiry transactions to the host's Web server, which in turn passes those transactions through the decision logic in the associated project and returns the results via the Web server.

### Applied Business Rules

The preferred embodiment of the invention allows for defined end user business rules to be executed through the decision system. Business rules are first defined within a decision system project. A project can comprise any of the following features:

Input and output data structures;
Characteristic generations;

### Models;

Reason codes;
Business rules and exclusions;
Decision strategies; and
Recommended actions.

### Designer Overview

The preferred embodiment of the invention includes a designer feature that allows the end user to create and refine projects by defining and combining individual project parts in an almost limitless number of combinations. From designer, the end user can view and test a project configuration as it is being built. The designer can be used to try different strategy methods and logic until they are perfected for runtime. In the designer, the end user works within the context of a project. That is, when a project is created, the end user defines its parameters according to the needs of the project. For example, an end user can create a first project that calculates scores based on applicant data, can create a second project for determining breakpoints for a preferred customer offer, and can create a third project for excluding data from the applicant pool. Each project has its own unique structure based on its purpose and the desired output.

### Decision System Tasks

An end user performs tasks in the decision system that are separated into three types: design, test, and runtime.

### Design Tasks

Design tasks are used to define and build the project parts and workflow. Logic and business rules are gathered and assembled. Tools and functions are provided in the designer and a projects explorer.

### Testing Tasks

Testing provides a collective view of the behavior and results of one or more executions of a project against sets of data. In order to test a project, the end user must have a batch, set, or collection of test case records. As a set, these test case records can be run against a given project. The process of testing a project includes both validating the project in the designer, generating statistical results for every step in the overall workflow of a project, and viewing these statistics in a bulk testing report.

### Runtime Tasks

Runtime involves a project that has been designed and tested. The decision system's runtime mode consists of the processing of requests with the necessary input data from runtime clients. At the end of execution, the output stream is generated.

### Data Definitions

Defining data is central to defining a project and is one of the first things the end user does at the beginning of a project's design. An inventory view provides one view of the data hierarchy, order, and the contents of a data dictionary, which defines all of the data structures and data elements used in the project, such as:
The runtime input stream structure;
Constant values;
Any intermediate derived values or temporary values that are calculated during a runtime process; and
The contents and structure of the output data stream.

The end user can create new data structures, add to and delete from existing data structures, and reposition data fields. The end user can perform all of these actions within the inventory view. The architecture supports the definition of hierarchical structures, which can be used in a variety of contexts, supporting, for example, the definition of data segments, value lists, and arrays.

### Workflow Functional Components Overview

Workflow functional components define a process or action to be carried out. There are three main workflow functional components:
Expression sequences;
Segmentation trees; and
Workflow lists.

### Expression Sequences Overview

An expression sequence assigns values to local fields and provides a means of modifying local field values. The expression assignment must be an arithmetic expression or another field of compatible type. Specifically, these values can be:
Literal numbers or strings;
User Defined Functions (UDFs);
Evaluated expressions; and
Any valid VarGen expressions, where VarGen is a proprietary language by Fair, Isaac.

### Segmentation Trees Overview

Segmentation trees can be integral parts used in the creation of a project workflow. One way to construct the project workflow is by arranging the workflow steps using segmentation trees. The end user can use segmentation trees to create complex decisioning branches resulting in:
Another decisioning branch; and
A workflow list initiating further or terminating processes.

### Workflow Lists Overview

A workflow list identifies a set of steps that are processed during runtime execution. They are referenced by a segmentation tree leaf node and are also available for reuse. Workflow lists appear in the inventory view in alphabetical order. The project workflow is the flow of execution of the project beginning with a specific workflow list designated as the root result list. Each list item of a workflow list points to a particular workflow functional component, such as an expression sequence or segmentation tree.

### Other Resources Overview

The end user can incorporate models and UDFs into the project design. Such resources provide means to apply predictive scoring and implement user-defined logic within a project.

### Models

Models are made up of characteristics and attributes and produce a predictive score at runtime for a given transaction. Tools are provided to define, edit and manage models. Such tools also generate necessary UDFs and other required data structures within a project.

### User Defined Functions (UDFs)

A User Defined Function (UDF) represents the logic to be contained in a single subroutine. A UDF editing tool allows the end user to write and edit functions. It provides means for using the VarGen language (a proprietary programming language) to define functions. The UDF editing tool provides syntax and error checking, include specific status bar formats, context-sensitive toolbars, popup menus, and a display options properties page. Also, the end user can cut, copy, and paste text within the UDF editing tools.

### The Project Workflow

The project workflow defines the use and the order of execution of the project parts. Specifically, it determines the way that data moves or flows through the project and the results. A workflow view displays project workflow configuration in a tree structure, allowing the end user to view the way in which project parts fit together and their order in the process.

### Constructing the Workflow

The project workflow consists of workflow lists, segmentation trees, and expression sequences. The end user builds the flow with these parts, placing them in the order in which the end user would like them to execute. Usually the end user selects parts already existing in an inventory. But, the user can also create such parts while building the workflow.

### Tracing the Process Flow

It is important that the process includes needed steps and executes them in the right order, otherwise the project will produce errors at runtime or simply fail to produce the desired results.

### Example

The project workflow is arranged within a segmentation tree.
The first segmentation tree implements an exclusion rule, and there are two leaf (result) nodes.
The excluded data exits the workflow at the first result node and the remaining data continues through the workflow extending from the second result node.

### Overview of Projects, Parts, and Procedures

The decision system works with projects constructed from parts that apply business rules and logic. A project represents a process that is designed to receive data and produce recommendations, decisions, scores, and the like.

### Order of Input and Output

A project is designed as a decision engine, to take input and produce output. Thus, it is important for an end user to take input and output streams into consideration while designing a project.

### Input and Output Streams

The data streams have several important features:
Order of data;
Segment occurrences (max and actual); and
Fields that are automatically generated and are hidden (project ID and actual occurrences).

### Input

The order of input data conforms to the order the end user has set in the decision system designer. All input data for a transaction must be passed in the proper order.

### Output

The order of output also conforms to the order the end user has set within the designer.

Sequential vs. Hierarchical Design Approach

A sequential approach appears on the surface to be a most straightforward approach. In this approach, a project workflow follows an ordered list of steps, or sequence. Many end users may likely choose this approach by instinct, but it is usually not the best choice.

The biggest drawback to sequential design is that all data is re-evaluated at each decision node, resulting in slower performance. In this workflow, data that has been excluded earlier in the sequence continues to move through the workflow.

To a new user, the hierarchical approach appears less obvious, on the surface, but is actually the better choice. In this approach, workflow components are set up in a hierarchical fashion, within a single workflow list and data is excluded as it moves through the workflow. The main advantage to this type of design is that knockout (exclusion) data is separated from the project flow, so only valid data is evaluated at each decision node. This results in enhanced performance. A more experienced user may find that this approach is, in fact, more intuitive. For a new user, this approach may seem more difficult to understand because the logic is embedded deeper into the project, such as in knockout rules, score calculation, and strategy assignments. However, as the user gains proficiency with the system and thinks in terms of workflow, using the hierarchical approach becomes much less of an issue.

It is noted that while it is possible to calculate scores using segmentation trees and expression sequences, it is more efficient to calculate scores using UDFs or models within a project.

### Putting Parts Together in a Workflow

A project's main workflow consists of segmentation trees, expression sequences, and workflow lists. Such segmentation trees, expression sequences, and workflow lists can reference other project parts including data structures, UDFs, and models, as well as other segmentation trees and expression sequences. A hierarchical list comprises part references in their order of execution at runtime. The end user builds a flow with these parts, placing them in the order in which they are to execute at runtime. Usually an end user selects from segmentation trees and expression sequences that exist in an inventory, but may also create necessary parts as the end user builds the workflow.

### The Root Workflow List

When a project is initially created, the system automatically creates a root or main Workflow List called root workflow list. Such a list is a starting point for processing at runtime and defines the workflow of the entire project.

### Expression Sequences Details

An Expression Sequence is one of the workflow functional components the end user can use to construct a project workflow in the designer. Like other functional components, they are reusable within the project. An expression sequence assigns values to local fields only. In the designer, expression sequences are presented in a three-column grid format:
The first column holds an identifier or name of the local field on which an assignment is targeted.
The second column holds the data type of the specified local field.
The third column contains the value, field, or expression that results in a value that will be assigned to the local field.

The rows in the grid are effectively a sequence of expressions. The end user can use an expression sequence in the project workflow to specify return codes, return strings, or other information to be sent back to a client during runtime, as well as to create values to be held in temporary fields.

### Example

An expression sequence is typically used for strategy assignments. For example, in defining a late payment strategy, the end user uses expression sequences to return the type of letter that will be sent to the customer. In an expression sequence defined as part of a result list at a particular leaf node in a segmentation tree, a “LetterCode” local field may be set to the string “SK3,” which might represent a friendly reminder letter. In another expression sequence within another result list attached to another leaf node, the same “LetterCode” local field might be set to the string “SP9,” representing a past due letter.

### Expression Sequence Assignments

An expression sequence is a functional component that consists of a sequence of value assignments. Each assignment associates a local field with an expression. The assigned expression must be an arithmetic expression or another field of compatible type. Values can be any of the following:
Literal strings;
Constants;
Local fields;
Input fields;
Derived fields;
Valid expressions (including VarGen); and
User Defined Functions.

### Segmentation Trees

Segmentation trees represent control flow logic, validation or policy rules, and strategy trees. Segmentation trees are often used as a main building block, or part, of a project's workflow. When the end user assembles the project workflow, the end user constructs the segmentation trees so that data moves in the order of workflow steps. The end user can incorporate segmentation trees at any step of a workflow.

The nodes of a segmentation tree are always executed top-down, from left to right. If a rule specified at a node is true, then processing continues with the next child node. If the rule is false, then processing continues with the next sibling to the right. The end user can use segmentation trees to create complex decisioning branches resulting in one of the following:
Another decisioning branch; and
A workflow list initiating further processing.

### Examples of Segmentation Trees

Segmentation trees are useful for dividing a population into sub-populations. The end user implement a segmentation tree in the workflow so that each time it is called it returns one sub-population. The end user can easily design a project so that, depending on the sub-population, a different series of workflow steps will be carried out. A segmentation tree can be simple with a single decision node that divides a population into two or more segments. It can also be quite complex, containing many possible paths and dividing a population into several segments. A more complex tree will typically contain subtrees, which are made up of all decision nodes within the tree and their child branches and nodes.

### Exclusion Trees

Exclusion trees are useful for excluding data from processing. Adding this type of tree to an end user's workflow enables the end user to remove undesirable data at the beginning of the workflow, and can save valuable processing time when implementing the decision engine.

### Example

A lender designs a decision engine for the purpose of screening loan applicants. The lender does not want to consider applicants with less than $30 k per year in income. The lender creates a simple exclusion tree to remove such applicants from the processing pool at the beginning of the workflow.

### Strategy Assignment Trees

Another type of tree that can be extremely useful in a decision engine design is an assignment tree. This type of tree assigns members of a population to specified categories based on any number of criteria that the end user specifies. Thus enables each group to be processed differently.

### Example

An end user designs a decision engine for collections management. The end user wants to use different criteria for selection depending on the number of days the account is delinquent. The end user creates an assignment tree to assign each record with a late payment to different strategies based on their level of delinquency. Those payments that are less than 30 days late receive a friendly reminder letter, and those payments that are 30 or more days late receive a past due letter.

### Decision Trees

A decision tree is similar to a decision table, wherein two or more variables or conditions are identified in order to determine a result. Decision trees can segment data by assessing many different variables, applying scoring models, etc. and produce a final result, or decision, about an individual data record.

### Segmentation Tree Nodes

A segmentation tree is, as its name implies, a tree structure used for segmenting data. The tree is made up of a series of paths (branches) and nodes. Nodes are points where some action or logic is applied, resulting in the data moving down another branch or exiting the tree. The nodes stemming from a branch must be mutually exclusive and collectively exhaustive.

### The Root Node

The Root node is the first node in the tree and must always exist. It is the parent node for all other nodes and branches within the tree. It cannot be deleted. A root node is created automatically when a new segmentation tree part is inserted into a project's inventory. It is the first decision node in the tree.

### Decision Nodes

Decision nodes are the most basic type of node in a segmentation. A tree must have at least one decision node, and the first is always the root node. This node type has two or more descending branches attached to child nodes. There are four different types of decision nodes and a decision node's type is determined by the type of test it applies. A test determines if the data matches the specified criteria. If it does, the child node is executed next. If it does not, the sibling to the right is executed. This schema includes the root node, which is always the first decision node and must exist in a segmentation tree. There are several decisions or tests that can be used to define the decision node's segmentation:
Boolean test (true or false);
Continuous subranges (<10, 10-19, 20-29, >29);
Discrete subsets (2, 4, 5 or 7; “pink”, “blue” or “yellow”); and
User-defined segmentation (VarGen expression).

If the node type is none of the above and ends the tree flow, it is an end result, or leaf node type.

### Leaf Nodes

Leaf nodes are also called external nodes, because they indicate that no further decisioning or segmenting will be applied to the data. Such nodes must have a result list attached. When the end user defines a decision node and determines its branching, a new node is inserted at the end of each branch. If the end user defines the properties of the decision node as an end results node, the node becomes a leaf node.

### Result Lists

A result list is essentially a workflow list attached to a leaf node. This referenced list serves as a series of processing steps to be applied to the data as it exits the segmentation tree.

### Boolean Test Nodes

A boolean decision node is used to specify a true/false rule. This enables the end user to test for a specific condition by using a single expression to be defined as true. This type of node automatically generates true and false branch nodes.

### Continuous Subrange Nodes

A continuous subrange decision node is used to define rules wherein the end user identifies ranges of data. This enables the end user to specify subranges with each defining a single branch, or to specify multiple non-contiguous subranges within a branch. For example, an end user sends values that are below a specified number or above another specified number down an out of range branch.

### Discrete Subset Nodes

A discrete subset decision node is used to specify rules of specific values or sets of values. This enables the end user to specify subsets, which represent one or more values, and are denoted by a decision variable that can be evaluated against a value list or constant, depending on the data type of the decision variable.

### User-Defined Test Nodes

In most cases, the rules needed to be defined for a segmentation tree node fit within the categories of boolean, continuous subrange, or discrete subset. However, an end user can create a user-defined decision node to use custom expressions for defining a segmentation. It is important to ensure that the mutually exclusive and collectively exhaustive requirement for this test type are enforced.

### End Results Nodes

An end results node is used to indicate an end to a decision branch. This type of node does not apply a test; it simply references a workflow list, a result list in this situation, to be executed. It cannot reference the root workflow list.

### Workflow Lists

A workflow list is another functional component. It constitutes a list of rules to be executed. Each list item of a workflow list points to a particular workflow step, such as a segmentation tree or expression sequence. The reference to one of these functional workflow components within a list item invokes execution of that part at runtime.

The root workflow list represents the main thread of execution for a project at runtime. Any workflow list can be used as a result list at an exit point of a segmentation tree. All end result nodes in a segmentation tree point to a workflow list. More than one node in a tree and more than one tree in a project may point to the same list.

### Structure of a Workflow List

The primary rule for creating a workflow list is that circularity is not permitted. For example:
A workflow list item may not point to a segmentation tree in which a leaf node points to the same workflow list.
A segmentation tree node may not point to a workflow list which contains any items that point to that tree.

### The Root Workflow List

The project workflow displays and controls the flow of execution of the project, which begins with a workflow list that is designated as the root workflow list. Such part cannot be deleted. It is special because it contains the main processing sequence for the decision engine. When the end user builds a workflow, the end user will reference a sequence of segmentation trees and expression sequences within this list. An end user can add, delete, and rearrange items in the list.

### Building Workflow Lists

Building a workflow list is a straightforward process. A workflow list can contain any number of steps. Each step can reference a segmentation tree or expression sequence. Steps can be created in any sequence.

### Referencing Another Workflow List

Referencing another workflow list is accomplished by first creating a segmentation tree and using the desired workflow list as a result list. This enables the end user to conditionally execute the workflow list.

### Attaching a Workflow List to a Segmentation Tree

When the end user defines an end results node in a segmentation tree, the end user must assign a workflow list to serve as the result list for that node. The end user can attach any workflow list, except for the root workflow list. The root workflow list is the main workflow list and a reference from a segmentation tree will result in a circular reference.

### Using Other Resources Details

Other resources include User Defined Functions (UDFs) and Models. These parts enable the end user to add more complexity to the decision engine.

Working with Models

Models seek to identify and mathematically represent underlying relationships in historical data, in order to explain the data and make predictions or classifications about new data. An analyst develops a model in order to make specific predictions based on real-world data.

### What is a Model?

There are several kinds of models that can be used for predictive scoring. In the preferred embodiment of the invention, models are made up of characteristics that can be discrete integers, continuous range integers, or expressions.

A discrete additive model is a scoring formula represented by a sum of terms, wherein each term is a non-linear function of a single predictor variable. Such models generally refer to relationships that exhibit no high order interaction or association. Additive models are of the form:

y=f₁(x1)+f₂(x2)+ . . . +fₙ(xn)

wherein each of the functions fₙ(x n) depends only on variable.

In the case of a discrete additive model, f (x) is represented by a mutually exclusive, collectively exhaustive set of indicator variables. A model consists of one or more characteristics. Each characteristic is mapped to a variable and will take on some value during runtime execution and score calculation. The variable itself may have been calculated and may depend on other variables and input fields within the project. A partial score is calculated for a characteristic by determining the attribute to be associated with the particular value of a characteristic. A weight value is a function of this attribute, and it is assigned to the partial score. The partial scores are added together to determine the total score.

Reasons (in the form of codes and/or strings) are also determined during the process of calculating a score. Several algorithms can be used to determine and assign reasons.

### Setting Project-Level Properties

Some model properties apply to all models in the project, rather than to an individual model. Such properties affect the way that the designer generates needed data structure parts and functions when the end user creates the first model for a project. It is noted that the end user can modify these properties after adding or importing models to the project.

### Score Weights

The score (also called a score weight or partial score) is the primary output/result of a model. The secondary (optional) output is score reasons. For each characteristic, a partial score is calculated based on the characteristic's attribute/value. For example, at runtime the characteristic of “number of late payments” will assign a score to a transaction. This score is weighed according to the attribute value, which is assigned a score based on the actual runtime value according to the attribute match. Such partial scores are then added to determine a total score for that model.

The score weight data type can be either integer or floating point. The end user can indicate whether expressions are allowed in score weights. If this option is selected, score weights can be defined as any one or a combination of the following: literal numeric value, a data field (input, local, constant, or derived) with a numeric value (integer or float), a valid VarGen arithmetic expression.

### Score Reasons

In project-level models properties, the end user indicates whether or not to use score reasons. By including score reasons in models, the end user can incorporate reason codes (adverse action codes) into models.

### Model-Generated Parts

Model generated parts include both global parts used by all models within a project and a UDF part specific to a particular model. If models already exist in the project and the end user creates a new model, the only part that is created with the new model is its corresponding UDF.

### Reason Codes and Messages

A Reason_Code_List value list is a generated data structure for storing reason codes and messages. The base data type of this value list is string. It maintains the list of reason codes, with the reason messages stored in the description field of the constant. The order of the codes in the value list determines the reason rank. This ranking is used when the score reason distances option is not selected for returning reason codes.

For example, if the maximum reasons to return is set to 3 and there are more than three codes that can be returned, the top three reasons are determined by their rank (order) within this value list. If the end user is computing distances, the top three reasons are determined by the computed distances, and this ranking is used for tie-breakers.

Reason codes and messages have a one-to-one mapping. The end user can only have one set of reason codes and messages to use within a project, and most users typically work with a standard set of codes/reasons for all of their projects.

### All Other Attributes

In the development of a scoring model, an analyst will select development sample data that are representative of the future population to be scored. Unforeseen circumstances, such as changes to an application or a new data entry system, can result in new data values that are not taken into account in scoring model development or the resulting scoring model. Accounting for the possibility of such data through the assignment of a score weight and adverse action code for an all other attribute range allows for the computation of a score at runtime.

### Unexpected Flag

Data values explicitly accounted for in the Model development may still be unexpected at runtime. For example, even though the credit bureau score data value corresponding to no credit bureau score available is a defined value in the scoring model, it may represent an unexpected, unanticipated occurrence. The end user may want to flag it and other such unexpected values and track occurrence over time. A high frequency of occurrence of unexpected values may warrant the redevelopment of the scoring model.

Furthermore, if data values for several model characteristics fall into an unexpected range, the resulting score may be invalid.

The model score is composed of the partial scores of one or more characteristics. If the total score is the result of too many unexpected values, then the score may be invalid. What constitutes an invalid score will be a function of the number of model characteristics (the more characteristics, the less likely that a few unexpected values will have a large impact on the score) and the end user's individual tolerance for unexpected values in the data. For example, in a fraud-detection environment, 0 unexpected values may be tolerated in the computation of a valid score.

The threshold can be implemented in the project workflow within a segmentation tree or an expression sequence using the following logic, based on the output from the “Number of Unexpected Values”:

if ( ( nb_expected > 3 )
{
invalid_score_flag = TRUE
]

The user can output the “Number of Unexpected Values” to track the number.

### Special Values

The “Special_Value_Mappings” value list is created when the scoring package is created. This list is populated with default values and these values can be assigned to range/values in a model. Because many models are developed using SAS data sets, this may be needed to specify values that indicate specific conditions.

### Model Results

Part of the Model-generated parts are the segments that report the scoring results. These segments are: “ML_Scores,” “ML_Scored_Characteristics,” “ML_Reasons,” and “ML_Reason_Computation.” They contain local fields which hold the different pieces of results information and are used for all models. At runtime, the last invoked model UDF produces the results.

The end user can view the results and designate any of the local fields within these segments to be written to output at runtime.

### Importing a Model

In the designer, the end user can directly import models using a decision system model XML format into an open project the end user has checked out. By default, the designer does not automatically generate a subpopulation characteristic for imported models, however if one exists, the model is created accordingly.

### Initial Score

When the end user creates a new model, the end user can specify an initial score. This value is used to align scores when multiple models are used within a project. Multiple Models can be created for handling multiple subpopulations within a single project, i.e. short time on file, long time on file and delinquent, long time on file and not delinquent, etc. The output for each subpopulation is initially an unscaled score. Each sub-population is then aligned to a certain good/bad odds scale, such that a score in one subpopulation will have equivalent odds to an identical score in another sub-population. The difference in odds across subpopulations is taken into account and an initial value is calculated to adjust the score of an individual model.

### Model Properties

The model properties are those properties defined when a new model part is created.

### Using Data Fields

When a model is defined, the end user maps model characteristics to other data fields.

Working with a Model

The scoring model is presented in a table with model characteristics and attributes, as well as the score associated with each attribute. The model calculates the score for each data record that passes through at runtime. The score is the numerical total of points awarded based on the data evaluated by the scoring model, or a total of the score associated with each attribute in the model.

### Characteristics and Attributes

A model consists of a series of characteristics and their attributes. The model assesses each data record at the characteristic level, and assigns a score based on the attribute of the data record for that characteristic. The end user inserts characteristics and their attributes into a grid structure.

### Characteristics

A characteristic is a predictive variable; specific information used to predict a future outcome and compute a score. Different types of characteristics can be used in a model.

A continuous characteristic, such as age, has a continuous set of values. For example, age might range from 18 to 90. Other examples are income in dollars, time at an address, or time on a job.

A discrete characteristic, such as occupation, is where no relationship exists between the various attributes (answers or values) that might be provided. Some examples are type of automobile, the color of hair, or location of property.

A generated characteristic is one generated from two or more variables. For example, a model might include a time at two addresses characteristic, which is generated from time at address and time at previous address characteristics.

### Assigning Data Fields

The end user can create fields in the project inventory and assign them to characteristics in a scoring model. The end user can assign the following fields to a characteristic: constants, derived fields, and input or local fields that are not part of an array or segment group. The base data type of these fields can be integer, string, or floating point.

It is noted that defining a model is essentially creating a series of characteristics and their attributes.

### Attributes

An attribute defines one or more characteristic range/values. For example, an individual with two automobiles and a policy that has existed for one year has the attribute of “2” for the characteristic “number of autos” and an attribute of “12” for the characteristic “number of months insured.” The “All Other” attribute is automatically created for each characteristic as a catch-all for all non-explicitly specified attribute ranges. In order to account for data values undefined in model development, the attributes of a characteristic must provide mutually exclusive, collectively exhaustive coverage of possible values over the data components' domain. The end user cannot delete this attribute.

### Assigning Range/Values

When the end user defines an attribute, the end user must assign a range/value to the attribute. The range/value can be a floating point, integer continuous, integer discrete, or string based on the type setting for the characteristic.

### Reason Codes and Messages

The “Reason_Code_List” is a value list, and each reason code is a constant within that value list and its message is the description of the constant.

The “ML_Reasons” part is a segment that holds all of the of the reason code results, as specified by the maximum number to return in the project-level properties. The “ML_Reasons” segment consists of the “ML_Reason_Code,” “ML_Reason_Rank,” and “ML_Reason_Distance” local fields.

### Computing Score Reasons Distances

The end user can choose to compute distances based on maximum scores (distance=score weight−maximum score) or user-specified baseline scores (distance=score weight−baseline score). However, if the end user allows score weight expressions, the end user is limited to baseline scores. At runtime, the score reasons distances method returns score reasons using a summed distance or maximum distance.

It is noted that only reason codes that have a positive distance are returned. Reason codes with zero or negative distances are not returned.

### Return Method

When the end user calculates score reason distances, the end user also specifies a method for returning score reasons. This affects the way that reason codes are sorted and then returned at runtime. The end user can choose either a summed distance by code method or a maximum distance by code method.

### Summed Distance by Code

This method combines the distances for reason codes that are returned for more than one characteristic. These summed distances are sorted in descending order, with a secondary sort by reason rank in ascending order. Next, the top N reason codes are returned by summed distance (where N is the maximum number to return), with reason rank used as a tie-breaker.

### Maximum Distance by Code

This method evaluates reason codes based on the distance calculated for each characteristic. With this method, the distances are computed and sorted in ascending order, with a secondary sort by reason rank in ascending order. Next, the top N unique reason codes are returned by distance (where N is the maximum number to return), with reason rank used as a tie-breaker.

### Using Reason Ranking

If score reason distances are not calculated, then the reason rank method is used. The relative rank (position) is determined by the order in which the reason codes are defined in the “Reason_Code_List” value list.

The model uses a hardwired distance method as the algorithm for calculations of reasons. Each attribute in a characteristic is assigned a reason code. Each reason code has a relative rank based on its position in the Reason_Code_List value list. Therefore, within a project, a reason code can have only one unique rank.

### Subpopulation Characteristics

The subpopulation characteristic is used in conjunction with reason code computation. A subpopulation is a distinct grouping of individual records having similar qualities or characteristics within the group, but whose qualities are different than other groups. A subpopulation has two attributes: “True” and “Other Subpops.”

The subpopulation characteristic is treated like any other characteristic in score reason computation. The end user can modify a baseline score if used and the score for the “Other Subpops” attribute, which are used for computing distances. The end user can also modify reason codes for both attributes. For example, models can be created for multiple subpopulations, i.e. a short time on file, a long time on file, etc. In order to indicate the contribution of the subpopulation to the score weights, the analyst uses an artificial characteristic. This artificial characteristic is a subpopulation indicator with two attributes (True, Other Subpops). For a specific subpopulation, all members of that subpopulation should fall into the “True” attribute. The current convention is to assign the weight of 0 to the “True” attribute, and to assign a weight reflecting the difference between subpopulation and total population odds for the “Other Subpops” attribute. If the end user wants to ensure that the subpopulation characteristic will always be returned as a score reason, then the end user assigns the “Other Subpops” attribute a very large weight, such as 900. In this way, the “Other Subpops” score effectively acts as a baseline score.

### The “True” Attribute

The first default attribute in the subpopulation characteristic is labeled “True” and has a range/value of 1 and a description of “always true.” The score default is 0.00 if a floating point is used and 0 if an integer is used. An unexpected checkbox is selected and the reason code and message are blank by default. Only the reason code and message is editable, while all other properties associated with this attribute cannot be changed. At runtime, any transaction being scored with this model falls into the “True” attribute of the subpopulation characteristic.

### The “Other Subpops” Attribute

The second default attribute in the Subpopulation characteristic is labeled “Other Subpops” and has a range/value of 0 and no description. The score default is 0.00 if a floating point is used and 0 if an integer is used. This should be set appropriately for reason code computation. An unexpected checkbox is selected and the reason code and message are blank by default. Only the reason code, message (if used), and the score are editable, all other properties associated with this attribute cannot be changed.

### Editing Characteristics and Attributes

If an end user changes project-level model properties, the result is some changes to existing models within a project. At any point in a project design, the end user can also edit any project model. Editing a project model involves modifications to the existing characteristics and attributes within a model. The end user can add new characteristics and attributes, as well as modify or remove existing ones.

### Validations

The end user can verify the content of a model at any time from a model editor, or can rely on an automated validation process when marking the project for testing or production.

### Marking a Project for Production or Testing

Model validation occurs automatically when an end user marks a project for production or testing. If any model errors are found, they are displayed in a process output window, as with any other errors found during such procedures. If the mark for production/testing validations are successful, then the decision system generates code in the model UDF. If a model is encrypted, the generated UDF code is also encrypted. When an end user unmarks a project for testing or production, the model UDF returns to its previous state.

Working with Model-Generated Parts

Some model-generated parts, such as those beginning with “ML_”, cannot be edited, except a write to output option. Fields within the “ML_Scores” and “ML_Reasons” segments are set to write to output by default, but other segment fields are not. The end user can change the write to output settings of these parts according to the desired output. The end user can also make some content modifications to some of the other generated parts, including reason codes and special value mappings parts. When the end user deletes the last model so that no model parts in the project inventory remain, the generated scoring parts are removed unless referenced by another project part. The exceptions are the “Reason_Code_List” and “Special_Mapping_Value” value list. These parts are not removed unless the end user manually deletes them. For every additional model created for a project, a new model part and UDF part are generated. When the model is deleted, its UDF is automatically removed.

It is noted that for projects with more than one model, the last model UDF invoked at runtime generates the results.

Working with UDFs

A UDF (User Defined Function) represents the logic to be contained in a single subroutine and returns one value. The data type of the return value defines the data type of the UDF. For example, an end user wants to calculate the sum of an array or segment. The end user can accomplish this with a UDF expression.

A UDF specifies a simple set of operations that manipulates input data values, possibly combining and transforming them into new values, and returns a single typed value. Physically, a UDF consists of a set of text statements written in VarGen, a proprietary Fair, Isaac programming language. For more details on this simple functional specification language see Fair, Isaac Decision System User Guide, Printing 1.0 (US) (Sep. 26, 2000), Appendix A, “The VarGen Language.”

### Public and Private UDFs

When an end user creates a UDF, the end user must specify whether it is a public or private UDF, to determine the scope of the UDF and how it is used within a project.

### Public Functions

In the decision system, a public function is defined as callable from anywhere within the project. It may be called from any expression in any segmentation tree node or expression sequence (if it does not take parameters), a model score weight expression, any other UDF, or anywhere a VarGen expression is allowed (if it does not take parameters). It may also be associated with a derived field within the project (if it does not take parameters), and be invoked when that derived field is referenced. A public function may take any number of parameters, but there are restrictions on where it may then be used.

### Private Functions

A private function differs from a public function in that it may be called only from other UDFs in the same project. It cannot be called from an expression in a segmentation tree node, and it may not be associated with a derived field data component, expression sequence, or model.

### Return Type

Each function has a return value. When the end user creates a new UDF, the end user must set the return type. The return type can be an integer, float, or string data type.

### Calling User Defined Functions

User Defined Functions may be called according to the following:
From an expression in a segmentation tree node, expression sequence, or model score weight;
By referencing a derived field data component that is associated with that UDF; and
From within another UDF.

Functions that accept parameters may not be called from anywhere except from within another UDF. For example, UDFs associated with derived field data components may only be associated with functions not taking parameters.

Similarly, a function called from an expression in a segmentation tree node must also not take parameters.

### Parameters

UDFs and all VarGen functions may accept any number of parameter arguments, separated by commas:

function(param1, param2, . . . , paramN), where each parameter must be the legal name of either:
A data field of type integer, float, or string; or
An array group of type integer, float, or string.

The names must be unique only within that UDF. Semantically, parameters are passed by value only. Though the runtime implementation of the language may or may not pass parameters to the function by reference for performance reasons, the value of any parameter changed inside a function is not transmitted or available outside the function after the call, unless it is assigned as the return value of the function or to a local field.

### Local Variables

The end user can define any number of local variables for a function from the three basic VarGen data types: integer, float, or string. Local variables are fields that can only be referenced by the UDF for which they have been specified. They must be initialized at the beginning of the UDF and do not retain their values in subsequent executions of the function. The scope of all local variables is the entire logic of that function. Only local variables and local field data components may be assigned values within a User Defined Function. No other data component type may be assigned a value. Assignment to a “this” local variable is the only means of transmitting a value back out of a function.

The “this” Local Variable

A predefined “this” local variable is always available in the function logic. The “this” variable represents the return value of the function, and so, by definition, is of the same type as the specified return type of the function. To return a value from the function, simply assign the desired value to the “this” local variable in an assignment statement, for example:

this=(AverageBalance/100)*2.

The “this” variable has an initial default return value based on the function return type, so if no value is assigned to the “this” variable in the function's logic, its initial value will be returned by the rule: if function returns string, integer, and float, then “this” is initially set to empty/null string, 0, 0.0, respectively.

Although the invention has been described in detail with reference to particular preferred embodiments, persons possessing ordinary skill in the art to which this invention pertains will appreciate that various modifications and enhancements may be made without departing from the spirit and scope of the claims that follow.

1-83. (canceled)

84. A computer-implemented method comprising:
receiving, at a remote server, data characterizing at least one rule for making decisions based on input data;
generating, at a client server by the remote server, the remote server being different and remote from the client server, at least a portion of a web page for receiving the input data, the portion of the web page corresponding to the at least one rule;
initiating, by the remote server at a decision server remote from both the remote server and the client server, a decision service for producing an output by applying the at least one rule to the input data, the output corresponding to at least one recommendation, reason code, decision or a score;
receiving, at the client server, the input data from a user via the web page, the input data modifying the output;
transmitting, by the client server to the decision server, the input data in a first format;
invoking, by the remote server, the decision service on the decision server to produce an output by applying the at least one rule to the input data, the invoking comprising sending data to the decision server in a second format different from the first format; and
delivering, by the remote server, the output to the user at the client server.

85. A method as in claim 84, wherein the at least one rule comprises at least one model, expression or a strategy.

86. A method as in claim 84, further comprising generating XML schema corresponding to the at least one rule; generating an XML parser for extracting the input data conforming to the XML schema; and, invoking the XML parser to extract the input data conforming to the XML schema from the web page.

87. A method as in claim 84, wherein the at least one rule corresponds to a project, the project corresponds to a plurality of rules.

88. A method as in claim 84, wherein the at least one rule is validated by a plurality of simulated transactions.

89. A method as in claim 88, further comprising generating a test report corresponding to the plurality of simulated transactions.

90. A method as in claim 84, wherein the at least one rule is received from a rule designing software, the rule designing software having a graphical user interface adapted for graphical illustration of the at least one rule.

91. A method as in claim 90, wherein the graphical illustration of the at least one rule is provided in a form of a tree or a graph.

92. A method as in claim 84, wherein the at least one rule corresponds to a project comprising expression sequences, segmentation trees and workflow lists arranged into a user-selected order, the expression sequences assigning values to one or more fields, the workflow lists corresponding to one or more workflow steps processed during a run-time execution, the segmentation trees arranging workflow steps into one or more nodes configured in tree branches.

93. A method as in claim 92, wherein the user-selected order is sequential or hierarchical.

94. A method as in claim 92, wherein the expression sequences are configured by using a table with at least three columns, the first column displaying an identifier of a data field, the second column displaying a data type of the data field, the third column displaying at least one of the field, value, or expression that is assigned to the data field.

95. A method as in claim 92, wherein the nodes arranged in tree branches are executed top-down, from left to right.

96. A method as in claim 92, wherein at least one of the expression sequences, segmentation trees and workflow lists reference at least one model.

97. A method as in claim 96, wherein the at least one model comprises one or more characteristics and one or more attributes corresponding to the one or more characteristics.

98. A method as in claim 97, wherein the at least one model is configured to assess a data record based on at least one characteristic, the at least one model is further configured to generate a score based on the at least one attribute corresponding to the at least one characteristic.

99. A method as in claim 97, wherein at least one characteristic corresponds to a predictive variable.

100. A method as in claim 99, wherein the predictive variable is selected automatically.

101. A method as in claim 96, wherein the at least one model is a discrete additive model.

102. A method as in claim 96, wherein the at least one model produces a score as a result of an execution.

103. A method as in claim 92, wherein the projects are configured using an inventory of project items, the inventory of project items comprising one or more expression sequences, segmentation trees and workflow lists.

104. A computer-implemented method comprising:
rendering, by a web server at a client server remote and separate from the web server, a web page including a first decision tree, the first decision tree comprising a first plurality of linked values to help identify a strategy corresponding to the first decision tree, the web page including graphical user interface elements corresponding to the first plurality of linked values;
receiving user-generated input via one or more of the graphical user interface elements on the web page modifying at least one of the first plurality of linked values in the first decision tree;
passing, by the client server to the web server, the user modified first plurality of linked values;
passing, by web server to a remote decision server, the user modified first linked values, the remote decision server being separate and remote to both the web server and the client server;
calculating, by the remote decision server, a second plurality of linked values based on the user modified first linked values and a pre-defined decision model;
generating, by the remote decision server, a second decision tree based on the second plurality of linked values, the second decision tree comprising a second plurality of linked values to help identify the strategy corresponding to the first decision tree;
passing, by the remote decision server to the web server, the second decision tree; and
rendering, by the remote web server at the client server, a second web page including the second decision tree.

105. A method as in claim 1, wherein the modified first plurality of linked values passed by the client server to the web server comprises an XML document, and wherein the modified first linked values passed by the web server to the remote decision server comprises an ASP file, the ASP file being in a different format from the XML document.

106. A decisioning service computing system comprising:
a client system;
a web server coupled to the client system;
a decision server coupled to the web server; and
a code generator computing system for generating (i) strategy service software on the decision server for executing strategy; (ii) an XML schema, (iii) an XML parser/builder for reading data conforming to the XML schema, and (iv) a web page that is loaded onto the web server for facilitating communication in ASP mode between the client system and the decision server;
wherein the generated XML schema is provided to the client system for collecting input data and ensuring the input data from the client system conforms to the XML schema, a copy of the XML schema residing on the web server to validate input data intended for the decision server;
wherein the client system sends data to the decision server via the web server in the form of an XML document and the web server sends a corresponding ASP file to the decision server;
wherein the web server calls the parser/builder to convert XML format data into a format that can be processed by the decision server and returns results via XML to the client system.

107. A method for developing rules using a decision engine, the method being implemented by one or more data processors and comprising:
converting, by at least one data processor, model files into data with a model editor component;
organizing, by at least one data processor, the data according to hierarchical structures;
importing, by at least one data processor, the data into a designer component;
defining, by at least one data processor, projects with workflow functional components, the workflow functional components comprising:
expression sequences,
segmentation trees, and
workflow lists;
assigning, by at least one data processor, values to local fields and modifying local field values with the expression sequences;
creating, by at least one data processor, project workflow with the segmentation trees;
identifying, by at least one data processor, a set of steps that are processed during runtime execution with the workflow lists;
designing, by at least one data processor, rules;
generating, by at least one data processor, rules, models, and strategies with graphical user interfaces;
producing, by at least one data processor, a predictive score at runtime for a given transaction with the models;
testing, by at least one data processor, the rules by tracking statistics on which rules, models, and strategies were used and how many times; and
modifying the rules, models, and strategies based on the testing.
